(19) United States
(12) Patent Application Publication
(10) Pub. No.: US 2004/0101312 A1
(43) Pub. Date: May 27, 2004

(54) AC power source light modulation network

(76) Inventor: Florencio Cabrera, New York, NY (US)

Correspondence Address: FLORENCIO CABRERA, 101 WEST 80th STREET # 10B, NEW YORK, NY, 10024, US

(21) Appl. No.: 10/643,099

(22) Filed: Aug. 18, 2003

Related U.S. Application Data
(60) Provisional application No. 60/406,837, filed on Aug. 29, 2002.

(51) Int. Cl. H04B 10/10

(52) U.S. Cl. 398/172

(57) ABSTRACT

An AC power source light modulation apparatus is used for broadcasting useful data from a computer system to one or more specialized optical detectors located within any given space illuminated by standard electrical light fixtures all connected downstream from this same power source. The AC power modulation impressed by this system on the power signal, causes imperceptible changes to the light output of electrical lamps being supplied electricity from this common AC power source. This invention may be installed at any AC power source located upstream of one or more standard light fixtures in order to induce changes that may include deltas in amplitude and phase in the luminous output of these light fixtures. Changes in the electrical ambient illumination are produced by this modulated power signal which result in the broadcasting of optical signals that are received, demodulated and decoded by a specialized type of optical data receiver. This optical data broadcasting network includes a new type of optical networking card or optical receiver, capable of demodulation and decoding changes in the characteristics of the light output of the electrical lamps, which are generally imperceptible to the human eye. The AC power source light modulation apparatus and the optical receiver units comprise an optical data broadcasting network that provides a low-cost and single-point installation for applications where the lowest cost and the simplest indoor wireless infrastructure is desirable by users. Including applications such as the automation of prices in retail and supermarkets and for use by other applications that require optical communications for data broadcasting and remote wireless networking systems.

### REFERENCES CITED: U.S. PATENT DOCUMENTS 5,193,201 March 1993 Tymes 5,838,166 November 1998 Katyl 6,198,230 March 2001 Leeb

### FIELD OF THE INVENTION

The present invention relates generally to optical data communications systems which employ optical signals as the carrier of information. The present innovation is an electrical light modulation apparatus and method that impresses upon lighting circuits, signals that are broadcasted by standard types of lamps and as a result are capable of data transfer to specialized optical detectors. These optical detectors are located within the networked environment and are capable of reception of digital signals by means of digital signal processing and decoding by a suitable micro-processor controller and circuitry.

### BACKGROUND OF THE INVENTION

It is often desirable to provide a communication system within an environment, in order to broadcast data from a common source to numerous receiver endpoints. It is known that such systems can use various forms of wireless communication in order to broadcast or transmit data from the source to the receivers. A common form of wireless communication is the use of radio frequency (RF) systems to transmit and receive data.

In a one-to-many broadcast or networked transmission system, the cost of the system is determined by the cost of the transmitter and more importantly, largely determined by the cost of the receiver. For applications that use very large numbers of receivers within the networked environment, the cost per receiver becomes critical and in many cases an RF receiver may be cost prohibitive for users. In other cases, the necessary hardware installation required to network an environment for a large number of receivers may represent a complicated and in many cases expensive undertaking. In these cases, it is desirable for users to have a low cost one-to-many or networked environment system that is inexpensive and is also easier to install, requiring less retrofitting and enabling a complete networked installation in a simpler and less expensive manner than comparable systems using radio frequency or infrared systems.

It is well known that a light source can be modulated in order to transmit information from the light source to a remote point which is generally in the direction of the light source or within the space that is illuminated by the light source. The modulated light from the source is generally received by a specialized detector capable of detecting signals both in the visible light spectrum as well as signals transmitted above or below the visible light spectrum; as is the case with ultra-violet and infra-red detectors which are also referred to as light detectors. In many cases the detector may take the form of a photo-diode or photo-transistor, or may take the form of a photo-voltaic or solar cell. In this type of system, the information content is received by the light detector and then is demodulated by an appropriate logic circuit that may include an embedded microprocessor capable of decoding and making use of the information.

An important improvement over the prior art is the fact that this invention does not require specialized ballasts in order to modulate the standard light fixtures located downstream from the power source being modulated. The ability to modulate the voltage of the AC current circulating within the network environment from a single point located at the power source, obviates the use of special ballasts such as those proposed by the prior art. This lack of need for retrofitting and making custom modifications to existing light fixtures, produces substantial cost savings for users.

The apparatus of this invention is installed at the AC power source supplying power to the luminaire and thus, every lighting circuit downstream of that location is then able to broadcast information by means of optical through the air signals caused by this invention. Another improvement over prior art proposed by this apparatus is that it enables the light modulation of many types of electrical lamps which derive their AC power from the same modulated AC power source. Whereas the prior art requires the replacement of each and everyone of the ballasts used in a given electrical lighting system, our proposed invention is designed to modulated from the power source many different types of fluorescent lamps without requiring any special ballast circuitry. This improvement provides considerable cost and efficiency advantages to the users. Users will derive a very substantial cost saving by not been forced to replace their existing fluorescent lamp ballasts with specialized ones.

Whereas prior art fluorescent lamp modulating ballasts are required for each and every lamp, the installation of this proposed invention system occurs only at one location: the AC power source for the electrical lighting load. This upstream singlepoint-of-contact provides complete system-wide impact and control over all lighting fixtures that may be connected to that same system or AC network. The prior art in light modulating ballasts is also presented with the problem that most buildings and constructions, either industrial, commercial or residential in the United States are supplied with three-phase AC power lines. Each one of these power line circuits is 120 degrees apart in the timing of the power signal relative to the other. This Phase differential between legs of the AC circuit means that prior art systems employing signal-locked types of detectors may be found in areas of illumination where two light fixtures on two different AC power legs may be providing equal total illumination, therefore increasing the difficulty in detection in a signal-locked manner. This invention provides an improvement over prior art for detection of light modulation signals in many commercial and industrial light fixtures.

For example, prior art custom light modulating ballasts are confronted by problems created by the need for signal-lock detection and caused by the complexity of three-phase synchronization with lamps that might be connected on different phases, making signal-lock types of transmission much more difficult in the presence of three phase power. This invention overcomes the need for signal-lock problem by using a method for modulation dependent on total incident ambient light, produced by any combination of phases L1, L2 and L3. This architecture for broadcasting is dependent on producing and detecting changes in time by sampling very fast the total incident electrical light.

By the use of digital signal processing, such as the use of a Fast Fourier Transform and a delta-sigma method of digital sampling by specialized DSP algorithms operating in the micro-controller of each detector, any changes in total changes in illumination are integrated into the time domain from the frequency domain and used in reference to a digital and dynamic comparator window. Therefore, this invention does not require signal-lock and thus provides another improvement over the prior art requiring signal-lock. Now, in terms of the need for synchronization with the signal source, the demodulation technique employed by this invention provides for digital signal processing algorithms that are able to discriminate between three-phases of power since their relative phase-differential is known to be 120 degrees apart. This permits for adaptive filtering and dynamic gain control so as to provide a digital selection of any one of the three phases as a source of timing. Therefore, a natural time base is extracted from any combination of phases by digitizing the wave form and filtering out one or two of the phases.

Relative to prior art in which special electronic ballasts are required for every single lamp in the data network, those skilled in this field understand that U.S. Pat. 6,198,230 Leeb and U.S. Pat. 5,838,116 Katyl are both directed to a system for transmitting data from a host computer by a modulated light source to a remote data processing system which is responsive to the light source.

The Leeb and Katyl Patents both disclose that a light source may be a fluorescent lamp, which has a ballast interposed between the bulb and the power main, or source of the AC current for the lamp. In both the Leeb and Katyl Patents, the data is provided to a transformer which is coupled between the ballast and the lamp, i.e. downstream of the ballast with respect to the AC power main source. This method disclosed by Leeb and Katyl may be disadvantageous when a space is illuminated by a number of lamps or groups of lamps.

In such installations like large retail stores, this multiplicity of lamps may result in the need to install hundreds of transformers between the ballast and the lamp, or new ballasts specially modified according to the Leeb and Katyl Patents. In the case of the present invention, we propose a clear improvement over the prior art in that our ability to modulate all lamps operating from the same power main AC source of electricity may be modulated by a single installation of one modulation transformer, located upstream of any and all electrical lamps. This improvement represents significant savings for users, who would not be forced to retro-fit their stores at considerable expense, in order to replace hundreds of ballasts with special ones.

Regarding potential applications for this technology, it is also known that product information can be provided at the point-of-sale using programmable shelf “tags” that include an electronic display. Such electronic tags can be programmed to display product and price information. By installing such electronic tags, the user is provided an advantage over conventional paper labels and signs, in that these electronic tags can be easily and automatically changed and updated without the need for the manual labor otherwise required every time there is a change. In this regard, electronic shelf tags which use a radio frequency in order to receive product data are generally known. A drawback with these types of radio shelf tag systems, is that the required hardware for transmission of radio signals inside the networked environment demands installation typically throughout the networked space, resulting in extensive effort and considerable expense.

In addition, each radio frequency shelf tag needs a minimum amount of circuitry and power in order to function properly. The required radio frequency circuitry is generally more expensive than the required circuitry required for tags using light modulation as a carrier of information. Accordingly, it would be beneficial to provide an electronic shelf tag system which received programming data in a cost-effective manner. The present invention provides to users a less expensive and simpler alternative to radio frequency systems for networking shelf tag systems. The present invention enables users to implement an electronic shelf tags that is less expensive than comparable radio frequency systems.

Regarding the use of power lines for the transmission of information, those skilled in this field know there are numerous systems for transmission of data using alternating current power lines. It is also well known that the body of this prior art seeks to superimpose or “inject” a high frequency sub-carrier on the powerline transmission. An important improvement over the prior proposed by this invention, is the method and technique for data transmission that does not require a complex sub-carrier data signal in order to achieve signal synchronization between the transmitter and the receiver.

Most of the prior art in power line data transmission is designed to achieve very high data rates by using highly complex data signals that enable the transmitter and receiver to overcome the many obstacles posited by the normal AC powerline environment, typically related to the residential and commercial settings: (1) noise generated by electrical motors; (2) standing waves created by open circuits like unused wall outlets; (3) changes in the circuit due to switches and other devices being connected on the AC powerline; (4) separate circuits that require signals to travel unknown paths and might result in disconnected transmissions between circuits; (5) radio interference in the power lines. These obstacles have led the field of AC powerline communications to adopt very high transmission frequencies that seem to be optimized in the higher parts of the spectrum, in a range that has been proposed to be from 4.5 MHz to 21 MHz.

For those skilled in the prior art, there are a variety of other known applications in the field of power line data transmission where it is necessary or desirable to modulate electricity in order to transmit information. Conventional power lines, however, typically present a high-distortion, high-noise environment in which reliable and fast data communication is often not possible. In addition to additive white Gaussian noise (AWGN), power lines exhibit noise that is synchronous with the line frequency (e.g., lamp dimmer noise), periodic noise (e.g., motor-generated noise), random noise, radio frequency (RF) noise and interference from other communications devices such as intercoms and security systems.

On the other hand, for commercial and industrial applications, this invention is designed to couple only with the electrical loads which are separate from the circuits traditionally associated with the body of prior art in power line data transmission. According to National Electrical Code in the United States and many other countries, the lighting load circuits or “luminaire” must be specifically separate from the rest of the power system in any three-phase power installation, due mainly to safety and building code reasons.

The provision for an independent panel board configuration provided by electrical safety code, permits this invention to operate separate from the typical domain of the power line data transmission field of use and thus, provides the wireless component of this field as an improvement and desirable component to users.

The present invention proposes a method of transmission that is able to overcome the high-distortion, high-noise environment by utilizing the 50-60 Hz ACcarrier wave form as the preferred medium for the transmission of information to the light fixtures and also by utilizing a method of detection that is able to overcome phase discrepancies and other noises and interference from the surrounding environment.

As it was mentioned above, the body of prior art more directly related to spatial light modulation has been mostly focused on specialized circuitry for modulation of fluorescent light fixtures by means of digitally controlled ballast systems, for example as disclosed by Katyl “Fluorescent light ballast with information transmission circuitry.”

The Katyl Patent utilizes specialized electronic circuitry to drive an electronic ballast, whereas this invention does not require any specialized circuitry for the electronic or standard ballast, but instead utilizes “stray capacitance” of the inductor and the inverter circuits to “pass through” the Pulse-modulation signals that have been impressed upon the AC carrier waveform by the apparatus of this invention called the Light Modulation Unit, which is distinctively located upstream of any and all standard types of lamps.

U.S. Pat. 6,198,230 by Leeb et al describes in the abstract a “Dual-use electronic transceiver set for wireless data networks” whereby an “apparatus for generating electromagnetic radiation has a first and a second utility.” The Leeb patent then proceeds to disclose an electronically controlled ballast and special ballast circuitry to produce the light modulating effect. All or nearly all of the light modulation references made by Leeb pertain to fluorescent lamps and their corresponding ballast circuitry and operation; such that the patent provides repeated descriptions of the operation of a fluorescent lamp and the ballast, the inductor circuit and the rectifier. In the light modulating ballast prior art and according to his referenced documentation, Leeb describes in detail the specialized ballast circuitry in order to achieve the light modulation, therefore, the scope and detail of the claims, embodiments and detailed description of the invention are all direct references to a special light modulating ballast, forcing users to retro-fit any lamps with this new type of apparatus in order to obtain any modulation of the related fluorescent lamp.

Technical references and documents mentioned by Leeb, make clear the existence of a substantial body of prior art in which light fixtures or lamps are used for a dual purpose, namely that of providing lighting and optical data. Therefore the abstract concept of a “dual utility lamp” as a claim for a novel invention of a technique or improvement over prior art does not seem to be unique in the face of other pre-existing patents referenced by the very Leeb disclosure. A vast number of prior inventions utilize lamps in this “dual-utility” manner and many are familiar with the dual use of a lamp as a source of illumination and also as a transmitter of information and such is not an improvement.

Most of the prior art in fluorescent lamp and ballast modulation, describe data transmission at rates that are of the same order of magnitude as that of the powerline frequency 50/60 Hz. Further to prior art in the area of dual use of the lamp for two utilities is to be found in other communication schemes that been proposed that do not use the lamp light as the carrier, but instead use the lamp fixture as an antenna for transmitting conventional radio wave or microwave signals. For example as in K. Uehara and K. Kagoshima, “Transceiver for Wireless In-Building Communication System.”

Another clear indication to support the fact that “dual use” of a lamp is not an innovation, is that a U.S. Pat. No. 5,424,859, June 1995, for example, where the inventors disclose techniques for mounting a microwave antenna on the glass surface of fluorescent and incandescent lamps. Therefore, it is obvious to anyone familiar with the prior art that the use of lamps for “dual utility” purposes is firmly established and well know generally. Leeb is very specific in the description of a special ballast circuit for a fluorescent lamp, all the while there had been in existence a number of prior U.S. Patent granted to inventions that disclose the use of a ballast with specialized circuitry to modulate a fluorescent lamp. Light fixtures providing a “dual purpose” as sources of electromagnetic radiation in the form of light and optical data are obvious and have been disclosed prior to Leeb.

On the other hand, this invention is a clear improvement over this prior art because of the innovation providing users a new utility derived from an apparatus that is able to modulate an entire building AC current from the source of that power and which does not necessitate specialized ballasts for each and every lamp.

The abstract of U.S. Pat. 6,198,230 by Leeb describes the invention in terms that would apply to all of the prior art, wherever a lamp has two-uses. Therefore, there was no improvement over the prior art in terms of the dual utility or dual purpose of the fluorescent lamps and any other “apparatus for generating electromagnetic radiation.”

More specifically, the present invention improves in several ways upon the proposal as disclosed U.S. Pat. 5,193,201 (Tymes) that describes “System for converting a received modulated light into both power for the system and image data displayed by the system.” The prior art describes a method for modulating the peak voltage points in the AC current in a manner consistent with frequency modulation, that is dependent of the timing of each cycle peak. The present invention provides modulation of the voltage across the zero voltage point by a logic circuit that utilizes siliconcontrolled-rectifiers, in such a way so as to be almost lossless and in a way that does not generate electromagnetic interference.

Moreover, the present invention provides the means for coupling the modulating apparatus to the normal building power-line with specific analog and digital circuits that enable safe and normal operation of the normal building powerline, in observance of electrical and building code. The present invention permits the use of the apparatus in large commercial, residential, public and private standard electrical systems, which is another improvement for users seeking to utilize this method in commercial systems.

The spirit and scope of the present invention is to provide a means for transmission of information on a building-wide basis that permits broadcasting of optical data by utilizing all lighting fixtures deriving their AC power signal the same modulated power source. In this regard, this disclosure provides a new building-wide type of transmission that goes beyond the previous art which attempts to modulate only fluorescent light fixtures.

A clear advantage of the invention is to achieve light modulation of any type of light fixture without the need for any costly or time consuming replacement or adoption of specialized circuitry, a key consideration being the cost associated with such large scale types of retrofitting for existing system. Therefore, the proposed invention is not limited to the scope presented by the prior art with regard to fluorescent light fixtures and their ballasts and it provides an improvement in the ability to modulate many types of lamps.

### SUMMARY OF THE INVENTION

The sprit and scope of this invention is to provide the most adaptive and flexible system and method for producing and impressing signals at the power source, upstream of any given electrical lighting network, so as to cause standard electrical lamps to produce optical data signals without the need for any retrofitting and without any specialized ballasts of any kind. This ability is the result of the principle of creating a delta in the transformation voltage-to-illumination function of the entire lighting network that is detectable by digital means by incorporating in the specialized receivers of this invention, special digital signal processing algorithms and a technique whereby delta changes in the ambient illumination are the basis for a two-state modulation demodulation scheme.

I have called the system of our invention a “Light Modulation Network.” In our system, wireless transmission of information is accomplished by means of producing imperceptible changes in the power signal that are transferred to the visible luminous flux of lighting fixtures and can be demodulated and decoded as useful data.

This invention works by means of circuitry disclosed below that causes voltage changes that are similar to voltage transients and are within the normal tolerance levels for voltage variations. These very small voltage changes cause light fixtures to produce amplitude changes with such timing that are imperceptible to the human eye. The modulation of the line voltage supplying the luminaire is generated by special control of a transformer by using silicon-controlled-rectifiers and different circuit logic control units. And may also be accomplished by a second embodiment also disclosed below, which utilizes MOSFET semiconductor switching methods for faster and repeated modulation of the power signal.

The present invention proposes the use a complete network of standard light fixtures for the broadcasting of information by means of ambient light signals within an entire building or any construction illuminated by standard types of light fixtures. A method whereby each data packet is broadcasted to the entire network by means of a single-point-interface with the normal powerline that is supplying current to an entire AC-circuit powered or “networked” environment in a multi-cast transmission to multiple receivers.

The method for optical data broadcasting disclosed by this invention includes an apparatus for modulating an entire AC-luminaire circuit at any given point of supply of power to the electrical lighting system in a building such as a retail store, a supermarket or any other type of commercial building, which in this case can be referred to as the network environment. This apparatus may be coupled to three-phase power systems by means of a custom delta transformer interface with the AC-current power feeder supplying electricity to the network environment. Such delta coupling allows for three-phase high voltage electricity to pass through and be modulated by the apparatus, while at the same time being compliant with safety and U.S. building and electrical codes (NEC.)

This invention transmits indoor wireless information by means of remote transmission of imperceptible changes or “deltas” to the power signal characteristics which cause imperceptible changes in the luminous flux or illumination produced by the electrical light fixtures being supplied AC power from this modulated source. Data may be transferred from a standard computer system, or from other suitable sources, to the memory buffer of our invention and is then converted into signals impressed upon the electrical line connected to standard light fixtures operating on an AC circuit. These signals are detected by special detectors that vary in design and characteristics according to each embodiment of our invention.

It is an object of the present invention to provide a communication system for an illuminated environment in which the light sources in the environment are modulated using a common AC power main signal.

It is a further object of the present invention to provide a communication. system using the illumination system for the environment in a manner that does not require the use of customized ballast circuits for every single lamp; nor does it require costly radio frequency wiring or hardware installation throughout such said space.

It is another object to provide an electronic shelf tag system using the standard illumination system of the retail setting in a data communication network in a manner that is cost-effective and is the simplest and most convenient for the users.

In accordance with the present invention, a system for data communication in a. space illuminated by a plurality of illumination sources that, are. powered by a common power feed or AC power main is provided. The system includes a modulation unit which is interposed in the common power feed OTAC power mains; in a common location upstream of all and every one of the illumination sources of electrical lamps. The power modulation unit is capable of inducing a change in the signal of the power feed in response to received data.

The changes induced on the power feed or AC power mains effect variations in the amplitude or in the timing of the phase of the illumination sources, which cause the standard illumination system to transmit or broadcast signals to one or more specialized detectors, also disclosed by the present invention. The received data is provided to the power modulation unit by means of a standard data source computer system. At least one of the receivers is within the illuminated space and is in communications via light modulation with at least one of the illumination sources or lamps.

The receiver is responsive to changes cause by the modulation unit. These light signals are perceptible to the logic circuitry in the receivers due to subtle changes in the waveform characteristic of the light sources, that are generally imperceptible to the human eye and that do not disturb the normal illumination conditions of the networked environment in any noticeable manner, because of their timing and characteristics.

One embodiment of the power modulation unit includes a specially modified type of electrical power transformer that includes the addition of “taps” or points of contact along the primary coil of the transformer. These taps in effect create diverse sections of the primary coil so that one tap might include all of the windings of the primary, while other taps include only a section of the total windings. of the. primary of the said transformer. This embodiment of the present invention includes a logic circuit that is able to switch between the previously described taps according to the data from the computer that is connected to the power modulation unit.

There are many different embodiments for the logic circuitry that is able to switch between taps of a transformer, however, by using the method disclosed herein it is possible to use the AC power mains to transmit information. The effect of switching from one tap to another is to cause a change in the output voltage of the transformer due to the fact that changes in the ratio of turns between the windings or coils of a transformer, result. in changes in the. power output from the said transformer.

This method for controlling the configuration of the primary or secondary coils by means: of logic circuitry, results in the ability to control the switching between taps according to external data received from a computer system. This method is based on electrical laws that determine the output voltage of a power transformer and are generally known to be:

Ep*(Ns/Np)=Es

The primary voltage input multiplied by the quotient of the number of turns in the, secondary coil to the number of turns in the primary coil is equal to the voltage output of the secondary winding or coil. These changes in the energy transform function result in changes in the electrical ambient illumination that can be used to transmit data signals.

The present invention discloses several methods for synchronizing the data signals received from the external computer data source with the electrical waveform represented by the alternating current typically oscillating at an average 60 hz in the United States and most of the world. One of these methods disclosed by the present invention is referred to as the Silicon Controller Rectifier SCR or triac method.

This SCR or triac method considers that in order for the changes in the transformer configuration to be perfectly timed with the data signals, the power modulation unit logic circuitry must first sample the AC current and then split up the positive and negative half cycles of the 60 Hz waveform, by running them through a series of op-amp and diodes in order to determine the zero crossing point of the AC current.

At the zero crossing, triggers are created and then fed to a 555 timing chip. Under this SCR or triac embodiment, electronic components are added to adjust the exact triggering time, just far enough away in terms of nano seconds from the zero crossing in order to have a consistent switch for the triacs.

This output is then fed to a flip-flop with inverting outputs to alternately choose which triac would switch by means of transistors. One of the triac switches is ON for most of the time, as the base current is flowing.

Switching occurs by means of the output of the flip-flops and transistor component, whereby a second triac switch becomes active and causes the current to be lowered by selecting a lower tap on the transformer; so that line voltage is lowered during on half cycle of the 60 Hz current wave form. Once these SCR switches are active they remain active for the entire half cycle until the next zero crossing. Because of this “latching” characteristic, the. use of SCRs as switching devices makes this embodiment of the power modulation unit a data transmitter capable of data rates up to 120 bytes per second.

Data pulses are received at any time by the flip-flop, however it would only become active on the time base generated by the 555 clock register. Then at the proper time from the AC current sampling and the time base of the clock, the flip-flop becomes active and selects the triac switch in a phase coherent manner. If the data input were to be shorter than one half cycle, it would not affect the triac timing, since the triac will naturally stay switched for an entire half cycle and thus guaranteeing that the data transmission is phase coherent. If the data were to be longer than one half cycle, then the flip-flop with continue to switch. the same triac until the data train is finished. The minimum being the half cycle in this modulation technique and therefore the expected data rate equal to 120 bits per second.

Certain light detectors in an embodiment of the invention, use the AC component that is visible from certain light fixtures as a clock to synchronize the reception of the detectors with the light modulation unit transmitter. The above disclosed method provides for an AC phase-coherent transmitter.

In a different embodiment of the present invention, we disclose a method for making several switching actions during the same half cycle, instead of only one switching action, in order to increase the data rate speeds achieved by the power modulation unit. This second embodiment uses a method whereby we decided to look for an adjustable and relative voltage .point that we could select instead of the zero crossing of the AC waveform.

In this second embodiment, we chose a threshold that we could adjust and be selected based on the voltage level from the down to the up cycle of the AC current. We use resistors on the input of the op amp to determine the thresholds for the op amps to turn ON and OFF. This functions adjustable,so that a pulse would-be derived on the positive going slope and the negative going slope of each half cycle.

When these pulses get to the 555 timer, we adjust the pulse width to a fixed width, This pulse width will be found on the output of the MOSFETs as an AC wave form, with data modulation. Two MOSFETs are turning ON and OFF normally with each half cycle of the AC current when ever there is no information being transmitted.

Whenever there is data coming in that requires modulation, these two MOSFETs turn OFF while the other two turn ON for one half micro-second and then the bottom ones turn back ON again. There is a similar mechanism to the SCR modulation, except that the MOSFETs are able to switch ON and OFF during the half cycle versus only once for the triacs. Instead of the SCR selection between one and the other SCR, in the MOSFET version,. two MOSFETs are running the AC wave form. When a pulse comes through, these two. turn OFF and the other two turn ON. for the exact duration of the pulse. The voltage is seen at the source and the gate is the bottom MOSFET. The logic of the circuit is to look at the source and observes the contents of the source in the form of a polarity requirement. Because there are two different types of MOSFETs being used, the polarity of the input will determine which set will be turning ON and OFF.

The line voltage being sampled from the “hots” line is being sampled for timing and this line goes: directly to the transformer;. A neutral line is being run through the MOSFETs and this neutral line is “felt” or has a direct result on the transformer by the MOSFETs based on which set of MOSFETs are running. So that one set of MOSFETs is driving one tap and the other set of MOSFETs is driving the second tap on the, transformer assembly. A data buffer precedes the input of data into the modulation unit. A first in first out data register unit will take the data and pass it on to the modulation unit at the timing that is produced by the action of the MOSFETs.

An optical receiver in, accordance with the present invention preferably is formed as a compact; multiplayer design that includes a suitable display such as a liquid crystal display LCD or other types of displays that are equally suitable for displaying information to a user. In some embodiments of the optical receivers used by the present invention, at least a portion of the light which is incident on the display layer is allowed to pass through and another portion of the light is reflected back to the user.

This coating may be referred to as a “transflective” coating and it is generally well known in the liquid crystal display (LCD) industry to those familiar with the prior art, as a substrate capable of both reflecting part of the light and being transparent to the other part of the light. In this embodiment, the use of the transflective layer enables the present innovation to position a photovoltaic layer directly behind the display so as to use the same surface visible to the user as both display and source of power. The innovation disclosed by this invention is the positioning of the photovoltaic layer directly behind the display. The innovation proposed by the present invention is the arrangement of these three layers one positioned directly behind the other, so as to minimize the total surface and so as to provide anew type of construct that combines the existing layers into an: innovative multilayered detector capable of useful use together with the power modulation unit described above.

Also in accordance with the present invention is a method of transmitting data within a network space; The method includes illuminating the network space with a plurality of illumination sources powered by a common alternating current power mains such that the waveform produced by such illumination sources is modulated in a simultaneous manner in response thereto to the signals impressed upon the AC current by the power modulation unit as disclosed hereinabove. In the case where one or more of the illumination sources has an associated ballast,the modulation signal is applied upstream of the ballast.

### BRIEF DESCRIPTION OF THE DRAWINGS

Further objects, features and advantages of the invention will become apparent from the following detailed description taken in conjunctions with the accompanying figures showing illustrative embodiments of the invention, in which:

FIG. 1 is a block diagram of a communication system using the illumination system for an environment to transmit data by modulating common power main supplying the illumination system;

FIG. 2 is a simplified schematic diagram illustrating an embodiment of a circuit for modulating the power main signal for use in connection with the system of FIG. 1;

FIG. 3 is a simplified schematic diagram illustrating an embodiment of a switching circuit for modulating .the power main signal for use in connection with the system of FIG. 1; and

FIGS. 4A, 4B and 4C are timing diagrams illustrating the modulation of a power main signal in accordance with one embodiment of the invention.

FIG. 5 is a simplified schematic diagram illustrating an embodiment of a delta transformer arrangement circuit for modulating the power main signal in a three phase system for use in connection with commercial poly-phase electrical systems. Each one of the phases is modulated with a method in accordance to the preferred embodiment.

FIG. 6 is a simplified schematic diagram of an optical receiver and data display device in accordance with the present invention;

FIG. 7 is a cross sectional view illustrating a preferred fabrication of an optical receiver and data display device in accordance with the present invention;.and

FIG. 8 is a simplified block diagram illustrating a portable tag editor.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

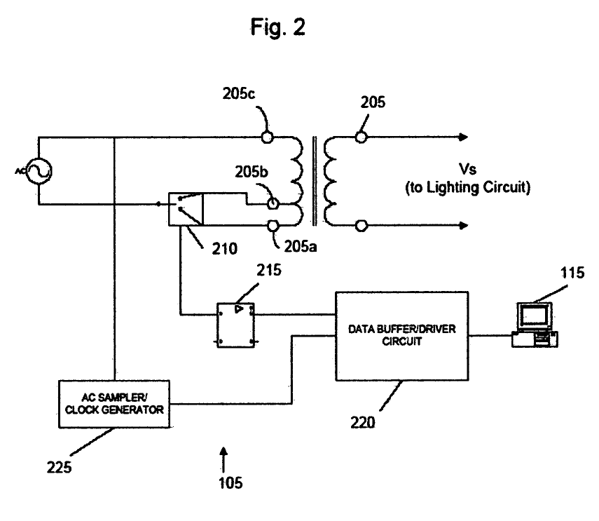

FIG. 2 is a simplified block diagram illustrating a system in accordance with one embodiment of the present invention. The system includes an AC power mains modulator 105 which is interposed in the alternating current —AC—power main which is conventionally supplied to a building or other space to be illuminated. The power modulator 105 is installed upstream of the power distribution point for the lighting circuits form space to be ill illuminated, such as between the incoming AC power main and the circuit breaker 110 or fuse box for the lighting circuits A host computer 115 is coupled to the AC power modulator 105 and provides data, such as from database 117, to be encoded by the power modulator 105.

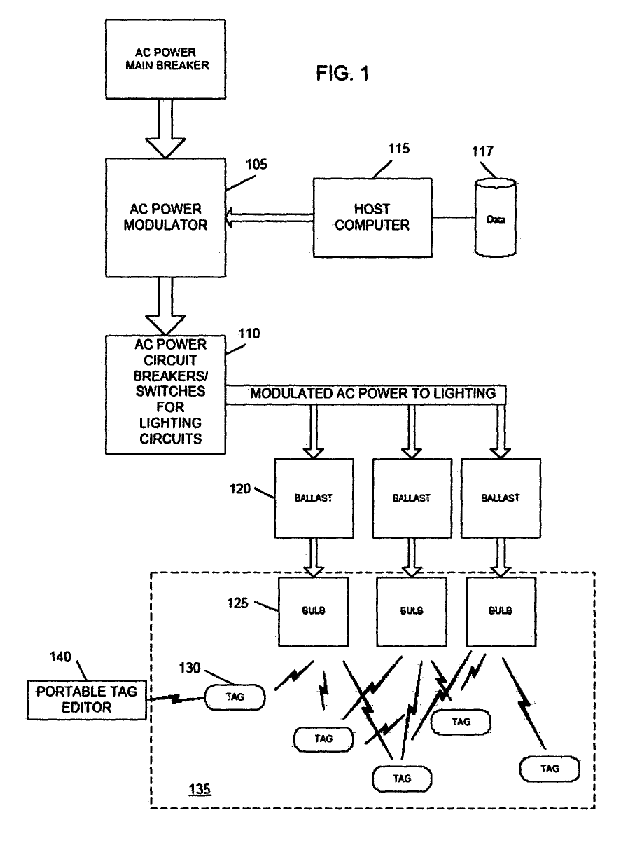

In a conventional lighting system, such as fluorescent lighting, ballasts 120 are placed in line with the AC power upstream of one or more bulbs 125. In the present system, the AC power provided to the ballasts 120 is modulated in a manner that will result in variations in illuminator intensity of the bulb(s) 125, such that the illuminations intensity is modulated in accordance with the data to be transmitted. The modulation of the illumination waveform in either or both amplitude and .phase is preferably not perceptible to the human eye, yet is detectable by one or more optical receivers or tags 130 which will be described in further detail below, include a display device such that the received data can be conveyed to users in textual and/or graphical manner. The system of FIG. 1 is well suited for the broadcast or network transmission. of data to multiple receiver endpoints, as in the case of an electronic shelf tag system.

A number of embodiments of AC power modulator 105 are contemplated. A common feature of each of the AC, power modulator embodiments is that the AC power mains signal is modulated at a point which is upstream of each of the lighting sources and associated ballasts that reside in the illuminated space 135.

FIG. 2 is a simplified schematic diagram that illustrates a first embodiment for an AC power modulator 105. The circuit of FIG. 2 includes a transformer 205. with tapped primary and secondary windings; The tapped primary winding of transformer 205 is coupled to a, switching circuit 210 which selectively couples one leg of the AC power main signal to either an outer connections 205a of the primary or the tap connection 205b of the primary winding. The second leg of the AC, power main signal is connected to the primary winding connector 205c. The effect of switching the primary between the tap connector 205b and the full primary 205a is to alter the ratio of turns in the primary to the secondary coils. Thus,the output voltage from the secondary winding of transformer 205 is then effectively switched between two different resulting voltages which may represent binary data.

The switching circuit 210 can take various forms, such as circuits employing silicon controlled rectifiers, power MOSFET semiconductor devices, relay circuits and the like. Switching between the two switch positions or states is controlled by a data signal which is preferably provided by a data buffer/driver circuit 220 that is coupled to the switching circuit via an optical isolator 215. The AC power modulator preferably includes circuitry to synchronize the data signal to the AC power main waveform. In this regard, an AC power sampling circuit 225 such as a comparator is coupled to the AC power main to derive a state referred to as being phase coherent, between the data signal and the phase of the AC current waveform. For example a time base may be derived by detecting the zero crossings of a 60 Hz AC waveform.

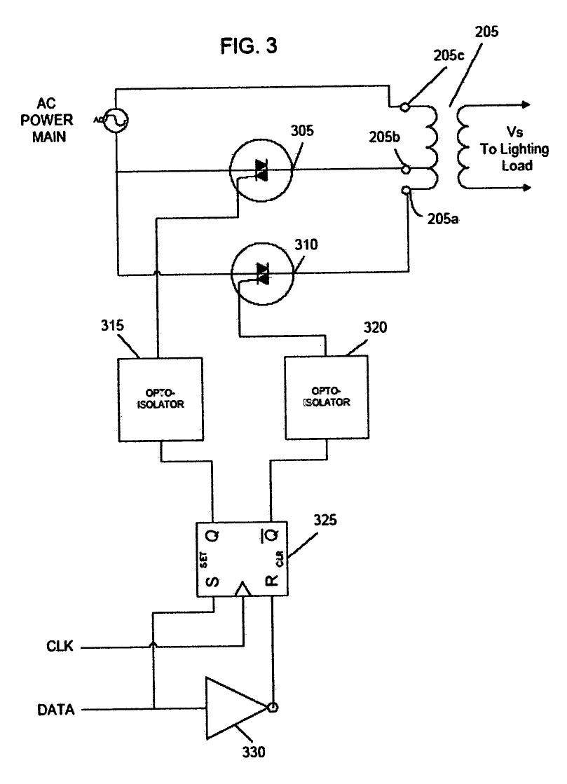

FIG. 3 is a schematic diagram illustrating an exemplary embodiment of a switching circuit 210 which uses silicon controlled-rectifiers SCR 305 and 310 as the switching elements. Referring to FIG. 3, a first SCR 305 is coupled between the tap connection 205b of the primary coil of the transformer and one leg of the AC power main. A second SCR 310 is coupled between the AC power mains and the outside connection 205a of the transformer primary coil.

The gate of the first SCR 305 is coupled, via an opto-isolator 315 to a Q output of a flip-flop 325. Similarly, the gate of the second SCR 310 is coupled via opto-isolator 320, to the complementary, not-Q, output of the flip-flop 325. The S/R inputs of flip-flop 325 are driven by a complementary signal representing the data to be transmitted which is provided by the host computer 115. The complementary signal can be derived by coupling the data signal to the S input of the flip-flop as well as the input inverter 330. The output inverter 330 is then coupled to the R input of the flip-flop 325.

The switching of the flip-flop 325 is synchronized by the clock signal, which is generated by the AC sampler/clock generator 225 (FIG. 2). To reliably switch the SCR's 305, 310, the data should be applied to the gate terminal at a time when there is voltage bias on the SCR.

Therefore, rather than synchronizing the clock signal to the zero crossings of the AC power main waveform; the AC sampler/clock generator preferably has a threshold value greater than five volts prior to switching. Alternatively, the AC sampler can detect the zero crossings and a small time delay can then be introduced in the clock signal to ensure that the AC power main waveform is of sufficient voltage to bias the SCR 305 and 310 at the time of the switching,right before the zero crossing.

In the circuit arrangement of FIG. 3, only one of the SCR's is operating in the ON state during any particular half cycle of the AC power main waveform.

Therefore, during each half cycle, the peak value at the secondary coil of transformer 205, Vs, will depend on whether the data is a binary value , which turns on the first SCR 305 or binary value 0, during the time when the second SCR 310 is turned ON. The difference in amplitude values of Vs in each half cycle of the AC power main waveform between a binary 0 and binary 1 is determined by the quotient of the ratio of turns of the primary to secondary coils of the transformer;

Because the first SCR 305 and second SCR 310 once switched remain “latched” in the ON state during the full half cycle (i.e. remain turned ON until the AC waveform crosses the zero voltage point) the data rate of the switching circuit of FIG. 3 is limited to 120 bits per second (120 Bps).

While this data rate is generally considered slow, it is adequate for many low data rate broadcast systems such as an electronic shelf tag system, for use in a retail store setting, where small amounts of data may be transmitted and where the data is not highly time sensitive. In these applications, the usefulness of the system to users resides in automating the otherwise labor intensive function of manually changing the paper shelf tags. In these types of applications, the broadcasting of data might occur during the night or at predetermined times when the optimal conditions might exist for an effective automatic change in the shelf tags by means of light modulation transmission technology.

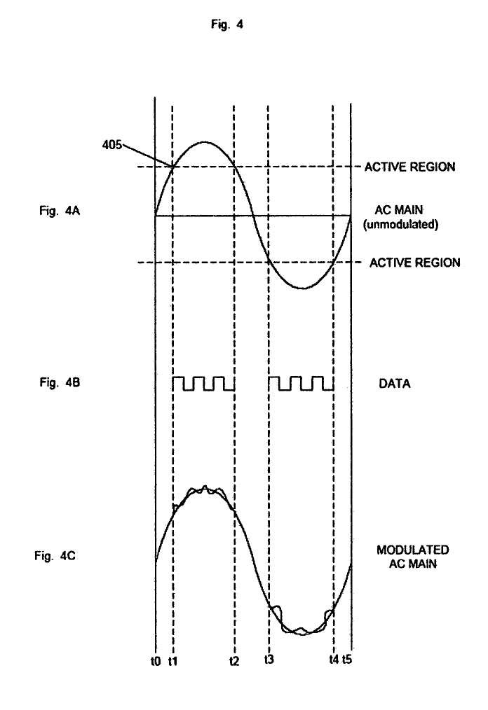

An alternative to modulating the amplitude of each half cycle of the AC power main waveform is to superimpose a higher data rate signal upon the said AC waveform. In order to generate a signal that is easily perceptible by the optical light detectors described hereinabove, it might be preferable to effect a super imposition of the voltage signals .near the. peaks of the AC. power. main waveform, although modulation along the entire slope of each cycle is possible up to a point near the zero crossing. This timing method is illustrated in the diagram of FIGS. 4A to 4C. FIG. 4A illustrates the timing of the unmodulated AC power main sinusoidal waveform. FIG. 4B illustrates an example of data bursts which are triggered by the AC main voltage level reaching a predetermined voltage point, such as a percentage of the value of the half cycle. FIG. 4C illustrates the modulated AC power waveform that is supplied to the lighting fixture load, with data signals superimposed in the form of multiple minute amplitude changes along the slope of the said AC waveform.

In the case of the timing mechanism, FIG. 4 illustrates the AC waveform sampler circuit 225 which is used to create a time base or gating function, based upon a predetermined value of the AC power waveform, as opposed to the zero crossings of the waveform used as the reference point. The use of a certain voltage value instead of the zero crossing as reference points for insertion of modulated signals provides certain advantages to the system, one being the greater number of signals capable of transmission during the same period of time. Another one is related to the optimal point along the AC power waveform where the light fixtures are most responsive to modulated data signals. By modulation of the AC waveform during these predetermined voltage reference points along the slope of the sinusoidal, the sensitivity of the illumination source to the modulating signal is increased and the reliability of the. transmission is improved.

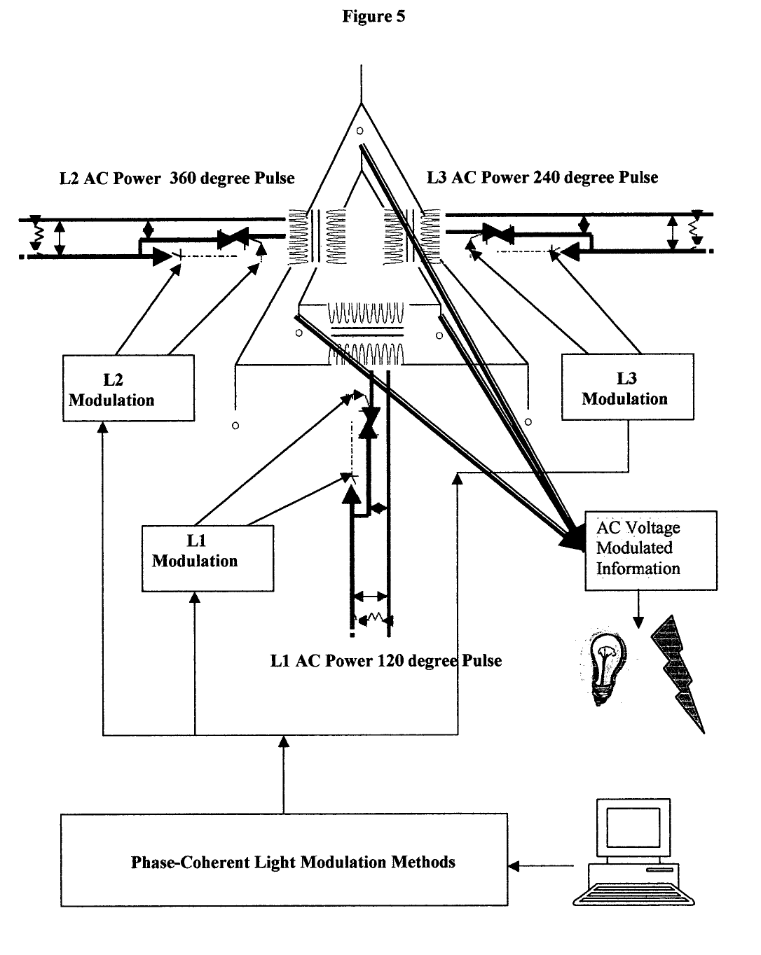

In order to modulate at data rates exceeding 120 bits per second, the switching elements used to select the transformer taps must take the form of non latching switches such as MOSFETS instead of the use of silicon controlled rectifiers. FIG. 5 is a simplified schematic diagram that illustrates one such embodiment of an AC power modulator suitable for applications with data transmission rates exceeding 120 bps.

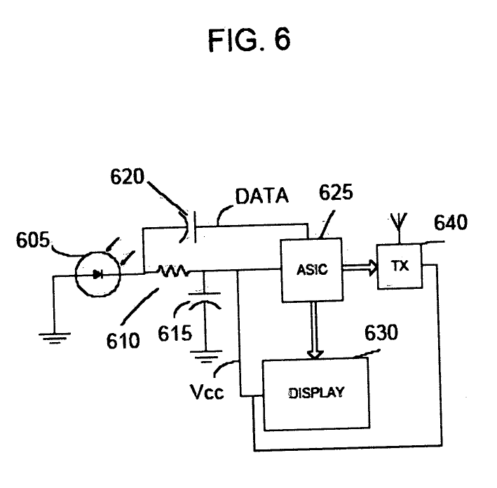

FIG. 6 is a: simplified schematic diagram of an embodiment of an optical receiver or tag 130. The optical receiver includes a photovoltaic device 605 such as a solar cell. In the presence of light, this solar cell 605 is capable of generating a certain voltage which is then passed through a resistor 610 in order to charge a capacitor 615

The voltage developed across the capacitor 615 is used as the supply voltage, Vdd for the tag 130. The voltage provided by the photovoltaic device 605 is responsive to changes in the illumination intensity and also to the timing of the phase of the waveform for the light which is incident upon the photovoltaic device 605. Therefore, changes produced by the power modulation unit in the waveform produced by the illumination sources result in intelligent information signals that are able to be detected by the receivers.

To detect and decode the data from the modulated illumination,the output of the photovoltaic device 605 is coupled, such as through a capacitor 620 to a data processor such as an embedded micro-controller which is part of an application specific integrated circuit (a.k.a. ASIC) 625. While not shown, one or more digital signal processing (DSP) filters might be interposed between the front end of the receiver and such an ASIC or MCU (micro-controller-unit). The MCU or ASIC 625 may generally include a suitable mathematical algorithm to extract data from the signal, in addition to other functions such as forward error correction and signal treatment for noise reduction.

In many applications, it is desirable to include a display device 630 coupled to the ASIC 625 or MCU to display text and other graphical information for users. For example, in a retail environment, the tags 130 may be located near products being offered for sale and such tags may take the form of either shelf price labels or merchandising signs. In some other embodiments of the invention, the tag 130 may also include an optional data transmitter 640.

This transmitter located within the tag may be used to provide an acknowledgement signal or error message, to a compatible receiver that may be coupled to the host data computer, in order to manage the information flow and enable diagnostics and other application specific functionality.

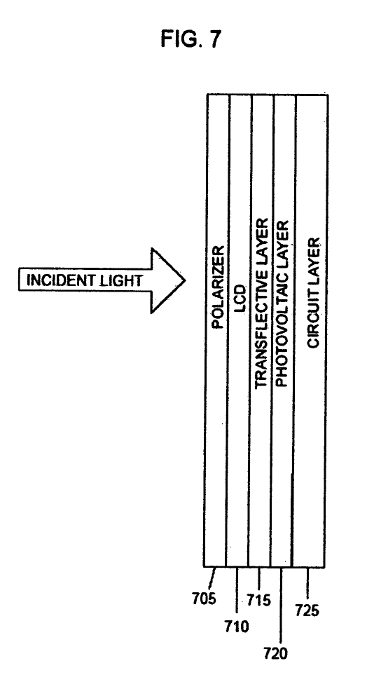

FIG. 7 is a cross sectional view of an embodiments of the construction of an optical receiver tag 130 which utilizes liquid crystal display (LCD) technology and which may also be any suitable display such as a bi-stable or other type of electrophoretic or Optical Resonant Gel Display. The illustrated construction provides an integrated and cost effective layered assembly.

A front layer can take the form of a polarizer 705 which orients the incident light in a specific polarizing plane. Alternatively, the polarizer layer 705 can be replaced with a layer of transparent suitable thin film or, plastic or glass. Behind this front layer, there is the, actual LCD layer 710 which generally includes a LCD layer interposed between two suitable transparent panes.

The photovoltaic layer 720 operates as the photovoltaic device 605 in FIG. 6. Behind the photovoltaic layer 720 is a circuit layer 725 which may be constructed using known flexible circuit technology, which is available to those familiar with the art; or may alternatively use rigid circuit board constructions on which the electronic components of the optical tag 130 circuit, such as the ASIC 625 are mounted and electronically interconnected.

Referring to the system diagram of FIG. 1, when the present optical data system is used in connection with a programmable shelf tag system, it may be desirable to provide a portable tag editor 140 in order to facilitate for the user the changing of the information displayed on any tags. The portable tag editor 140 can be used to manually update or correct data in tags 130 by locating an operator within the close proximity to a tag. For example, if. a tag is required to be reconfigured or replaced, the information. pertaining to that particular tag may be updated directly from the handheld unit.

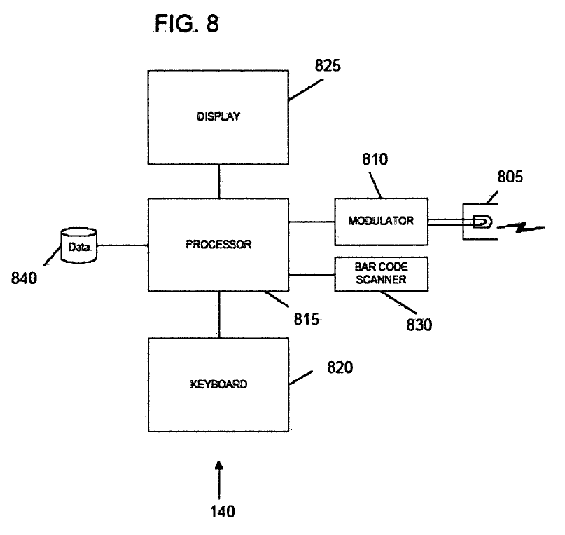

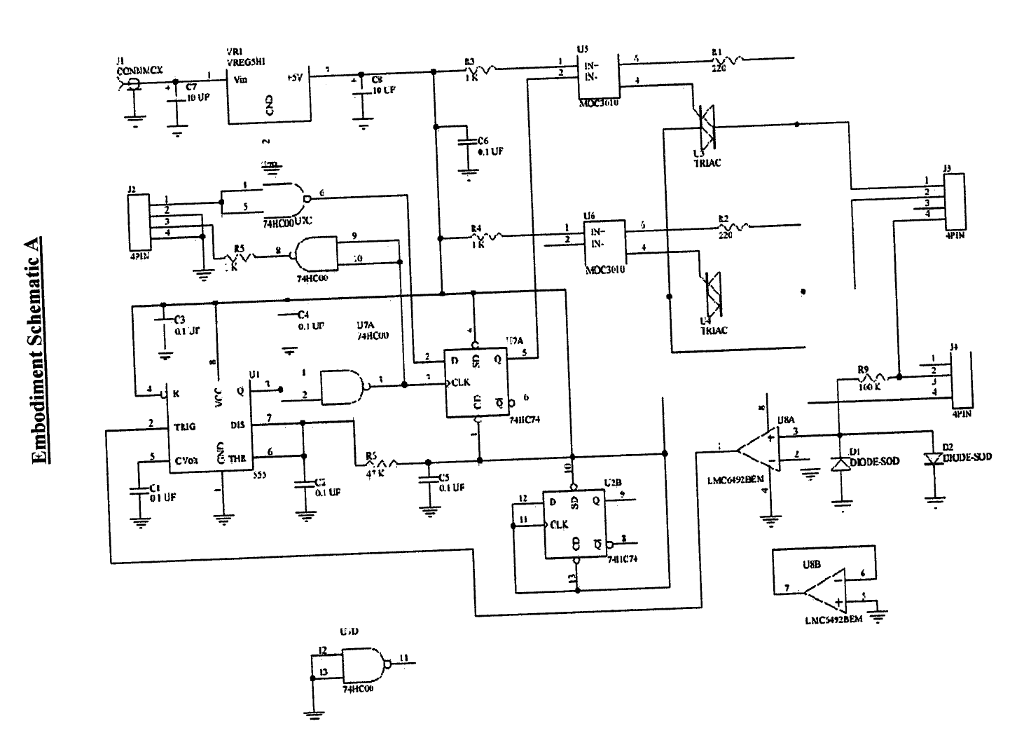

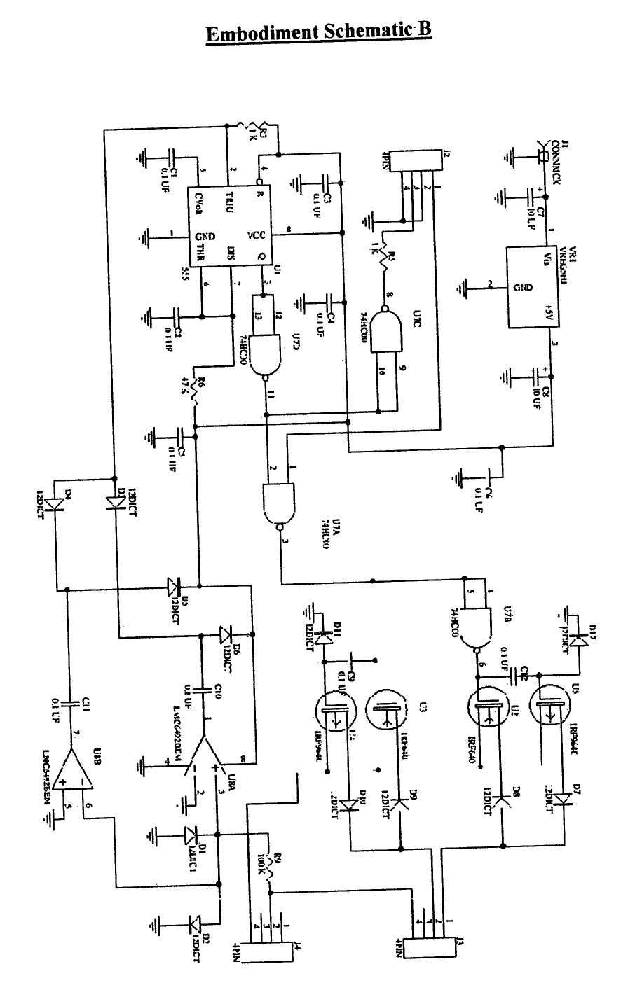

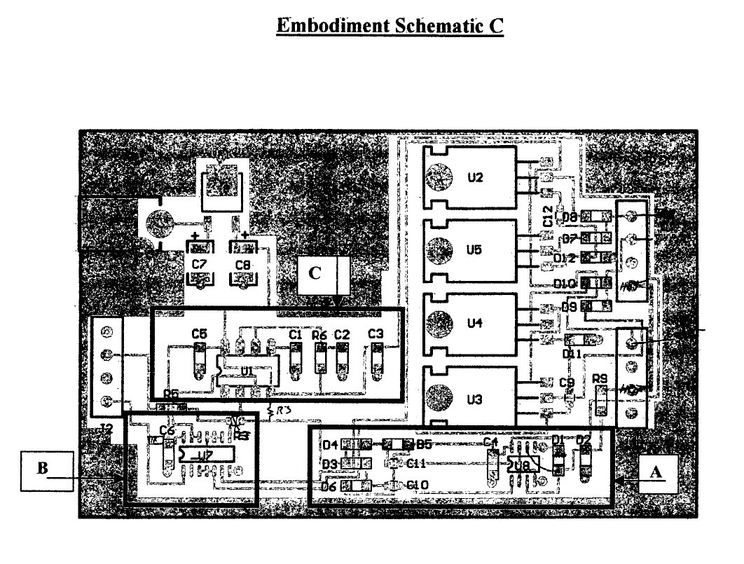

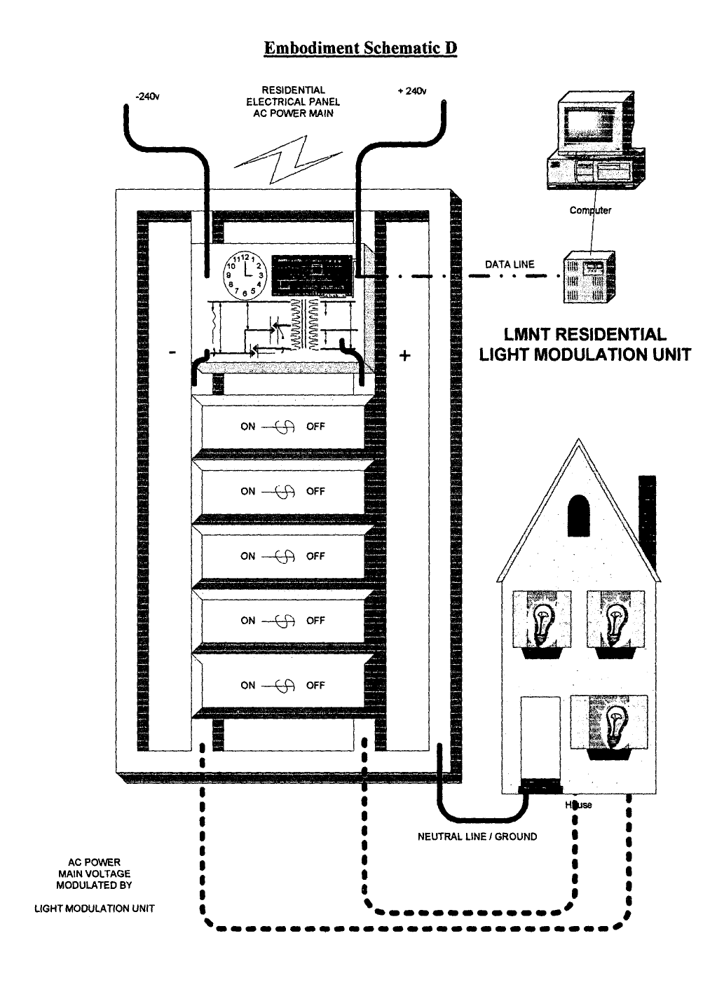

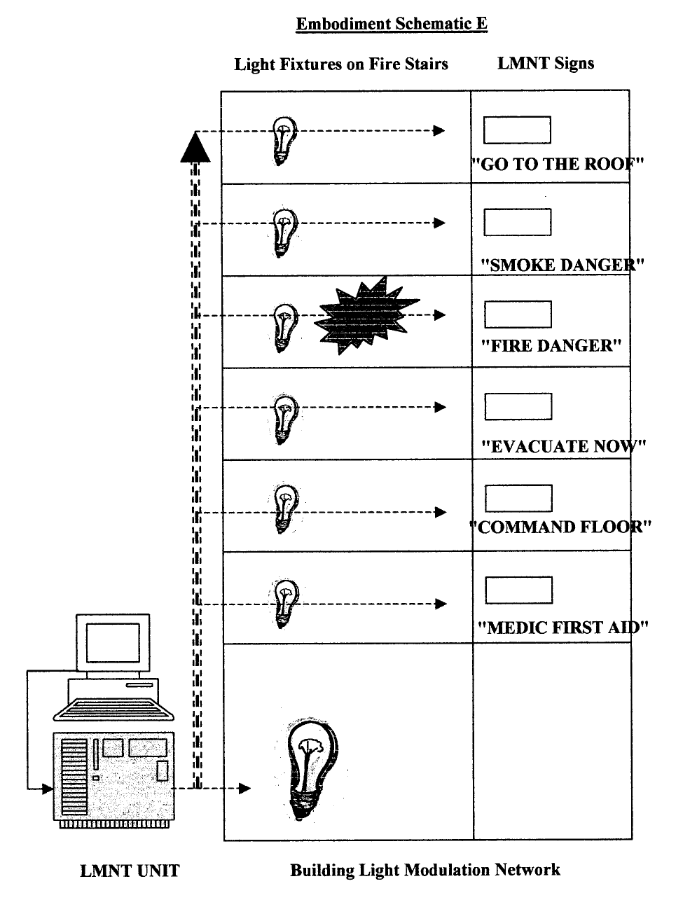

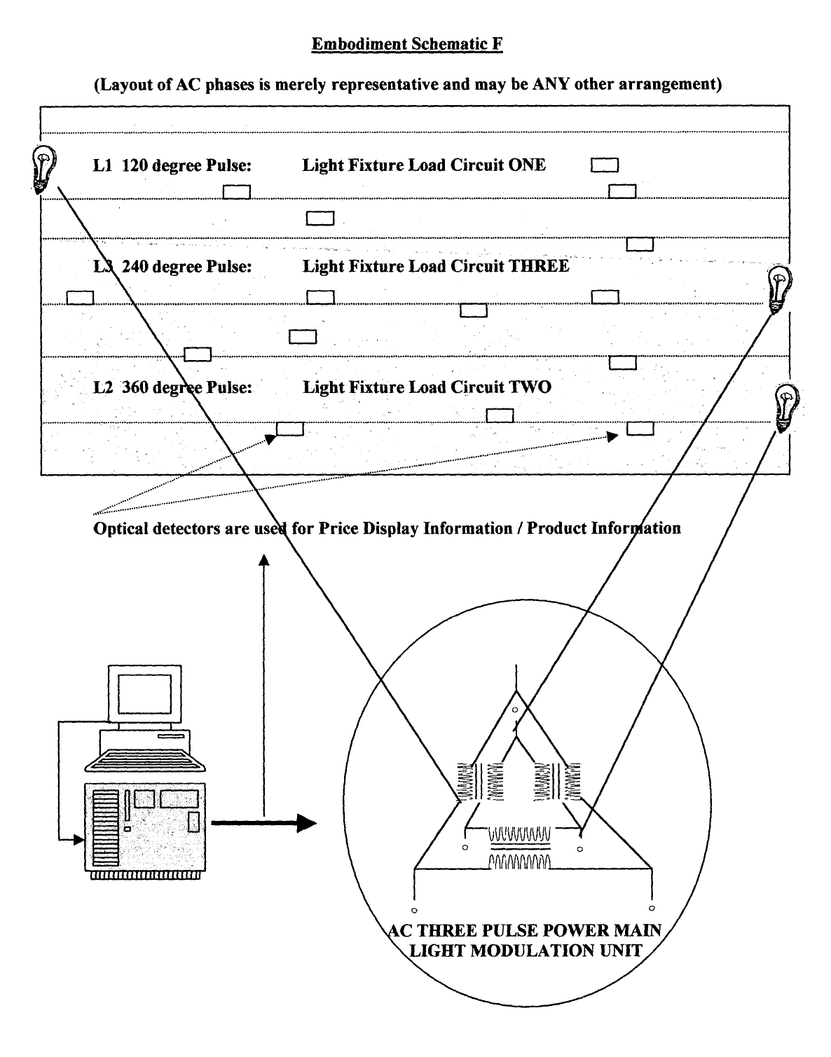

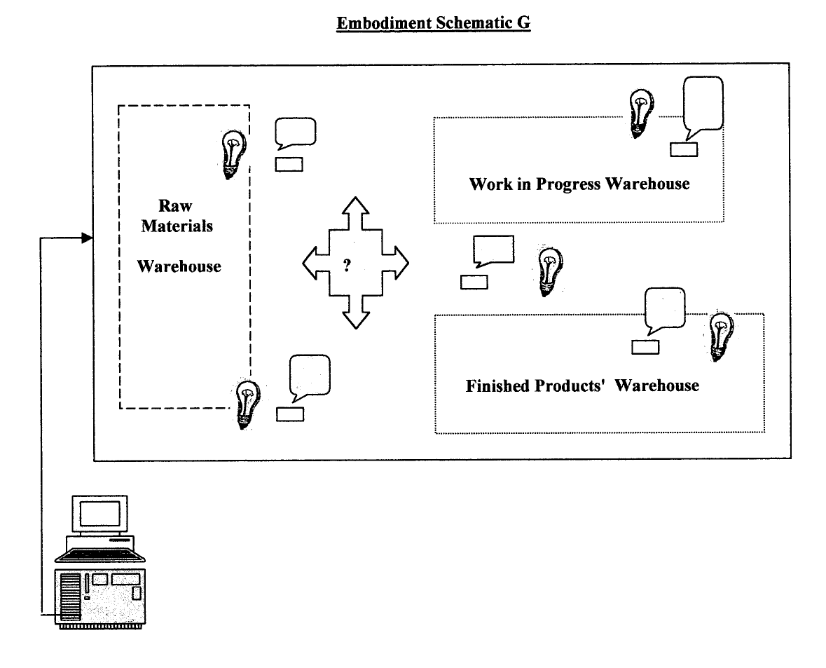

FIG. 8 is a simplified block diagram further illustrating a portable tag editor 140. The tag editor 140 preferably includes a light source 805 which may have its illumination intensity modulated 810 in a manner that is detectable and decodable by tag 130. The modulator 810 is coupled to a processor 815. The processor 810 provides the data be sent to the tag 130 to the modulator 810. The tag editor 140.preferably includes a keyboard, or other suitable input device for entering and editing data to be provided to the tag 130. A conventional display device 825 is coupled to the processor 815. Optionally, the tag editor 140 may include a bar code scanner to directly access product SKU information. The product information may be used by the processor 815 to retrieve related information that may be useful to the users.

The present system and methods employ conventional artificial lighting, such as fluorescent lighting, mercury vapor, high pressure sodium, metal halide, incandescent light and other types of illumination sources that provide illumination to an environment that is networked by the installation and use of the present invention.

Optical receivers are responsive to the modulated illumination and receive the data from the power modulation unit by means of signals produced by the external input of data. The system is able to transmit and receive information by virtue of impression and detection of minute. changes in the waveform produced by the illumination sources due to the hereinabove described innovation. The present invention proposes to create a complete network environments in any given space illuminated by lamps powered from the same AC power feed or power main. The present system provides a cost effective communication and broadcast system that is particularly well suited for applications with very large number of detectors, such as an electronic shelf tag system and also applications like merchandising signs in retail and supermarket environments.

Although the present invention has been described in connection with specific exemplary embodiments, it should be understood that various changes, substitutions and alterations can be made to the disclosed embodiments without departing from the spirit and scope of the invention as set forth in appended claims.

### DETAILED DESCRIPTION OF THE PREFERRED EMBODIMENT

Further objects, features and advantages of the invention will become apparent to those skilled in the art from the following detailed descriptions taken in conjunctions. with the accompanying figures and. commentary about the. illustrative embodiments:

Embodiment Schematic A illustrates an embodiment for a light modulation circuit board. This circuit first samples the AC current and then splits up the positive and negative half cycles by running them through a series of op amp and diodes in order to determine the zero crossing point of the AC current. At the zero crossing, triggers are created and fed to a 555 timing chip. Components are added to adjust the exact triggering time, just far enough away from the zero crossing in order to have a consistent switch for the triacs. This output is then fed to a flip-flop with inverting outputs to alternately choose which. triac would switch by means of transistor.

One of the triac switches is ON for most of the time, as the base current is flowing. Switching occurs by means of the output of the flip-flops and transistor component, whereby a second triac switch becomes active and causes the current to be lowered by selecting a lower tap on the transformer; so that line voltage is lowered during on half cycle of the 60 Hz current “wave form.”

Once these SCR switches are active they remain active for the entire half cycle until the next zero crossing. Because of this “latching” characteristic, the use of SCRs as switching devices makes this version. of. our. light modulation unit a slow data rate transmitter, capable of data rates up to 120 Kbps only.

A provision is made for the flip-flop to receive data from an external source and this is the data that causes the flip-flop to change from one triac to the other. Thus, the alternating function would only be active upon receiving data and then it would become active at the rate imposed by the 555 clock. The switching of the 74HC74 is a critical function of the SCR Modulation Board as this is the method which creates a phase-coherent lock with the AC current.

This is a critical function for reliable transmission of information using this method: synchronization of the data transmission with the AC 60 Hz wave form. Data pulses are received at any time by the flip-flop, however it would only. become active on the time base generated by the 555 clock register. Then at the proper time from the AC current sampling and the time base of the clock, the flip-flop becomes active and selects the triac switch in a phase-coherent manner.

If the data input were to be shorter than one half cycle, it would not affect the triac timing, since the triac will naturally stay switched for an entire half cycle and thus guaranteeing that the data transmission is phase coherent. If the data were to be longer than one half cycle, then the flip-flop with continue to switch the same triac until the data train is finished. The minimum being the half cycle in this modulation technique and therefore the expected data rate equal to 120 bits per second.

Embodiment Schematic B illustrates a second preferred embodiment for this invention. Whereas the silicon controlled rectifier circuit of FIG. 1 latched every half cycle and was thus limited to data rates of 120 bps whenever modulating a 60 Hz voltage, this other circuit provides for several switching actions during the same half cycle in order to increase the data rate speeds. So, instead of looking for the half cycle we decided to look for an adjustable and relative voltage point that we could select instead of the zero crossing. Basically, we chose a threshold that we could adjust and be selected based on the voltage level from the down to the up cycle of the AC current. [symbol] methods for selecting the trigger point for the pulses by [symbol] ue in our gate so that the timing of the pulses was relative [symbol] We use resistors on the input of the op amp to determine [symbol] o turn ON and OFF. This function is adjustable, so that a [symbol] positive going slope and. the negative going slope of each [symbol] ret to the 555 timer, we adjust the pulse width to a fixed [symbol] efound on the output of the MOSFETs as an AC wave [symbol] are turning ON and OFF normally with each half cycle of [symbol] e is no information being transmitted. Whenever there is [symbol] oduation, these two MOSFETs turn OFF while the other [symbol] ro-second and then the bottom ones turn back ON again. [symbol] o the SCR modulation, except that the MOSFETs are able [symbol] he half cycle versus only. once for the triacs. [symbol] SCR selection between one and the other SCR, in the [symbol] ETs are running the AC wave form. When a pulse comes [symbol] and the other two turn ON for the exact duration of the [symbol] e source and the gate is the bottom MOSFET. The logic of [symbol] rce and observes the contents of the source in the form of a [symbol] there are two different types of MOSFETs being used, the [symbol] nine which set wilt be turning ON and OFF. [symbol] e being sampled from the “hot” line is being sampled for [symbol] ctl to the transformer. A neutral line is being run through [symbol] l line is “felt” or has a direct result on the transformer by [symbol] ich set of MOSFETs are running. So that one set of [symbol] and the other set of MOSFETs is driving the second tap on

A data buffer precedes the input of data into the modulation unit. A first in first out data register unit will take the data and pass it on to the modulation unit at the timing that is produced by the action of the MOSFETs.

Embodiment Schematic C

Block A

This is the triggering mechanism sub circuit which synchronizes the triggering with the threshold voltage value.

U8 6492 op-amplifier

C4 Filter capacitor

D4, 5 and D6

C10 and C11

D1 resistor 3.3k and 10 k potentiometer

D1 and 10 k potentiometer set the threshold for a point on the slope of the half cycle where the pulse or pulses are triggered. The diodes together with the capacitors help build the trigger points for the pulses. The trigger occurs where the threshold meets the trigger point both on the up cycle and on the down cycle. The speed of data transmission will be determined by the number of pulses that are generated. The physical limitations for the number of pulses are found at the transformer core magnetic characteristics. There are two methods for transformer switching. The use of the primary presents a limitation based on the magnetic core characteristics. The use of the secondary winding of the transformer enables the use of much higher pulsing rates that do not present magnetic thresholds due to the transformer core characteristics.

Block B

This is the section that changes the triggers into pulses and then the pulses go on Block C

U1 555 timer

R6 resistor and C2 capacitor determine the width of the pulse

C1 and R3 are an important component for the operation of the 555 clock

Pin 4 readies the 555 chip for another pulse cycle

Block C U7 is an AND gate network used to drive the data out to an external device and also drive the data out to the MOSFETs. These AND gates together with the MOSFETs actually make a logic decision about the change in state. If you have two highs on both lines, then you get a low output. Everything else gives you a high except for two highs which give you a low This is the logic gate for. the. data. If this gate is not high, then all the change drivers on gate 2 will not be passed on to pulses. The data train drives line 1 for AND gate. We leave gate 1 high and then whenever gate 2 is high then the MOSFETs will be driven. Therefore, the rate of data upon gate 1 will be translated into the pulse rate that is driving the MOSFETs and in this manner, phase coherence is achieved with the AC current and the light modulation signals produced by the data train being transmitted.

Gate 2 is being driven bathe triggered pulses from Block B.

The AND gate network is therefore being driven by both the data train and also by the pulses being triggered by Block B. So, that this combination produces the phase coherent state for transmission. The position of pulses along the slope of the AC wave form is versatile except for, areas close to the zero crossing. Therefore, we adjust the gate so that it is available to turn on anytime just after the zero crossing and just before the next zero crossing. This would make available the incoming data for modulation. pulses at a time just after and just before the zero crossing points; where due to the state of the AC current, these pulses would be harder to detect.

Therefore, there is a threshold near the zero crossing points The pulse width is adjusted to select the broadest area along the slope of the AC waveform. Block C will be making adjustments to the timing of the pulses so as to maximize the number of pulses impressed upon the wave form.

Embodiment Schematic D is a representation of an AC Power Source Light Modulation system for use in a residential application. In this case, the entire circuitry is contained within the space of the residential power panel board and is designed in such a way so as to incorporate special noise reduction and filtering elements so as to provide both analogue and digital filtering of the related residential power line noise sources. The spirit of this embodiment is for the AC Power Source Light Modulation system to be also available for residential uses and is the subject of a continuation application that shall make reference to this schematic, based on the commonalities of this invention and yet the requisite customized adaptations for suitable residential use.

Embodiment Schematic E provides an illustration of an application for the AC Power Source Light Modulation system for use as part as a building emergency management and evacuation system. In this embodiment, also the subject of a continuation application, the invention is made available for use to control messages broadcasted to special EXIT signs so as to provide users with emergency instructions that are produced in conjunction with the Fire command and other safety systems. For example, in the case of obstructed stairways, special EXIT signs located in that stairwell would advise users not to enter. Likewise, the system would provide suitable emergency evacuation messages. This alternative embodiment provides for a fail-safe technique whereby the EXIT signs would fallback to battery operated power in case of an AC power system failure and would revert back to the original illuminated EXIT message in case of a power outage.

Embodiment Schematic F this is an illustration for a preferred embodiment type of application for the AC Power Source Light Modulation system, for use in the retail and commercial environments where users desire a low cost system for automation of price and product information. In combination with the specialized receivers of FIG. 7, this schematic provides an example for one of many alternative arrangements for the three phase circuit layout and the use of a delta-transformer arrangement in order to provide complete system modulation of the entire poly-phase electrical lighting network.

Embodiment Schematic G is an illustration for an application in the industrial arena, whereby electronic signage may be used to convey messages to production line workers about the contents of production batches, work orders and other dynamic data that may be useful for use by users in the front line of production.

What I claim as my invention is:

1. A method of transmitting optical data within a network space, comprising: illuminating. the network space with a plurality of illumination sources powered by a common alternating current power source and then applying a modulation signal to the alternating current power source such that the illumination of each of the plurality of illumination sources is modulated in response thereto, providing optical data signals.

2. A power modulation unit which imposes a modulation signal on. an electrical power waveform, comprising: main input terminals for connection to an external electrical energy source; a transformer coupled to the input terminals, said transformer having a first and second ratio of turns between a ,primary winding and a secondary winding; a switching circuit operatively coupled to the transformer, the switching circuit being responsive to a signal to selectively switch between one of the first and second ratio of turns of the transformer; modulated electrical power output terminals coupled to the transformer and for external connection to a lighting load.

3. An apparatus for modulation of the power signal supplying electricity to one or more electrical lamps so as to produce changes in the light output of these lamps and resulting from the switching mechanism of a transformer in which a primary tap selector is activated based on a synchronization circuit and is activated by data signals from a computer system and resulting in optical through the air signals by the electrical lamps.

4. The method for interfacing the apparatus of claim 2 at a location near the AC power source so that all lamps being modulated are located downstream of the modulation signal and in such a manner so as to enable the use of standard types of lamps and ballast combinations for different types of standard electrical light fixtures.

5. The method for creating an optical broadcasting network by modulation of the electrical power supplying electrical lamps by means of the apparatus of claim 2 which impresses voltage changes that result in changes in the luminous flux of light fixtures.

6. The method for broadcasting optical data signals through the air, by means of modulation of the brightness levels of an electrical illumination network comprised of one or more electrical light fixtures, a network of electrical light fixtures all being supplied electrical power from the apparatus of this invention and comprising one or more specialized optical receivers capable of reception of these optical signals.

7. The method for optical through the air communications by means of remotely creating changes in the illumination levels of an entire lighting network or luminaire consisting of two or more light fixtures supplied power from the apparatus of claim 2.

8. The method for synchronization of data and the electrical current waveform in an AC light modulation system whereby optical signals are created so as to convey information and data to specialized detectors using digital signal processing for demodulation and decoding, employing a digital signal processing technique whereby a dynamic comparator is created by continuous and rapid sampling of the ambient light.

9. The method whereby voltage modulation of the electrical power supplying one, two or more electrical light fixtures connected to this apparatus is generally imperceptible to the human eye due to the synchronization of data and the waveform of the electrical current by means of a microcontroller based software program.

10. The method and apparatus for ambient light modulation of the brightness of any environment illuminated by electrical light fixtures, whenever these light fixtures are powered from a common electrical energy source or any sub-branches of that same electrical energy source, and are all connected to the apparatus disclosed by the present invention at any given location in the electrical power distribution network.

11. The method and apparatus for AC power source light modulation whereby the voltage modulation is impressed upon the power signal by means of an electronically controlled transformer, switching between a tapped primary to secondary and a normal primary to secondary winding ratios, based on timing each switching action occurring without creating electromagnetic interference nor significant amounts of heat due to the switching occurring at a time when the AC power signal is near or at the zero voltage crossing point of the waveform.

12. The method and apparatus for producing optical signals in standard types of lamps by causing modulated electrical energy to supply from an upstream location, one or more electrical light fixtures, including gas discharge lamps like fluorescent lamps in a manner such that users may obtain the ability to broadcast information from these existing lighting fixtures without having to retrofit or change in any manner the existing light fixtures.

13. The method and apparatus whereby the electrical energy supplying one or more light fixtures is used as the carrier of information in order to cause electrical lamps to produce changes in a lighting network so as to broadcast optical signals that are detectable by digitizing the AC waveform produced by these lamps; and conveyed optically to one or more optical detectors provided with an analogue to digital converter and a microcontroller capable of transforming these signals into useful information.

14. The method for modulation of a commercial AC powered lighting circuit by means of a delta transformer arrangement which provides for modulating the power signal in each one of the three phases by the apparatus of claim 9 so as to produce changes in the three phases supplying power to an electrical lighting network.

15. An optical receiver with a design architecture which incorporates a display layer positioned to be visible by a user, a transflective layer positioned behind the display layer as needed, a photovoltaic layer positioned behind the display layer and a circuit layer positioned behind the photovoltaic layer; the circuit layer being electrically connected to the display layer and the photovoltaic layer.

16. A power modulation apparatus comprising an electrical energy waveform sampling circuit, a data buffer circuit, the data buffer circuit having a data input terminal, a data output terminal and a clock input terminal, the data output terminal being electrically connected to the control input terminal of the switching circuit, the clock input terminal being electrically coupled to the electrical energy waveform sampling circuit and the data input terminal is connectable to an external data source.

17. The system for data communication in a space illuminated by a plurality of illumination sources wherein the power modulation unit further comprises: suitable input terminals for connection to an external electrical power source; a transformer, said transformer having first and second primary terminals, a tapped primary terminal and first and second secondary terminals, the first primary terminal being electrically coupled to the first input terminal, the first and second secondary terminals being connectable to an external illumination circuit such as one or more electrical light fixtures.

18. The power modulation unit of claim 2, wherein the switching circuit further comprises first and second suitable semiconductor switching devices such as silicon-controlled-rectifiers; the first semiconductor switch being coupled between the second terminal and the tapped primary terminal, the second semiconductor switch being coupled between the second terminal and the second primary terminal, the gate of the first semiconductor switch is responsive to the data output signal from the data buffer circuit and the gate of the second semiconductor switch is responsive to the complement of the data output signal from the data buffer circuit.

19. An AC power light modulation unit comprising: electrical power input terminals for connection to an external electrical power source, a transformer, said transformer having first and second primary terminals, a tapped primary terminal and first and second secondary terminals, the first primary terminal being electrically coupled to the first power input terminal, the first and second secondary terminals being connectalble to an external illumination circuit; and a switching circuit interposed between the power input terminals and the transformer, the switching circuit selectively connecting the power terminals to either the first primary and tapped primary terminals or to the first primary and second primary terminals in response to a received external data signal.

20. A method of transmitting data within a network space, comprising: illuminating the network space with a plurality of illumination sources powered by a common electrical energy source ; and applying a modulation signal to the electrical energy waveform such that the. total illumination. within the network space. is. modulated in response thereto by means of small variations in total brightness that are imperceptible to the human eye due to their short duration and the timing and coding methods.

21. An optical receiver, formed in a multilayer construction, comprising: a display layer positioned to .be visible to .a user, said display layer being at least partially light transmissive; a photovoltaic layer positioned behind the display layer; and a circuit layer positioned behind the photovoltaic layer.
